(19) United States
(12) Patent Application Publication
(10) Pub. No.: US 2007/0198393 A1
(43) Pub. Date: Aug. 23, 2007

(54) Method and system for auctioning bonds using a full-time public network

(76) Inventor: Mark H. Springer, Thousand Oaks, CA (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(21) Appl. No.: 11/358,912

(22) Filed: Feb. 22, 2006

(51) Int. Cl. G06Q 40/00

(52) U.S. Cl. 705/37

(57) ABSTRACT

A method for auctioning bonds to a trading house or by a trader using a full-time public network, including several steps. A connection is established (160) to a full-time public network. Trading house or trader criteria received via the full-time public network is accepted (162). Risk analytics is performed (164) to facilitate identification of acceptable bidders. At least one bid is accepted (166) from at least one acceptable bidder via the full-time public network. Each accepted bid is evaluated (168) based on the trading house or trader criteria to determine whether the bid satisfies the criteria. At least one bid is selected (170) as a winning bid determined to satisfy the trading house or trader criteria. A system for matching traders and trading houses includes at least one trader computing system (212), at least one trading house computing system (216), and auctioneer computing system (218) having several operating modules.

### CROSS-REFERENCE TO RELATED APPLICATION

This application claims the benefit of priority to U.S. Provisional patent application Ser. No. 10/830,694 entitled “METHOD AND SYSTEM FOR AUCTIONING FUNDS USING A FULL-TIME PUBLIC NETWORK,” filed on Apr. 23, 2004, and is incorporated herein by reference in its entirety.

### FIELD OF THE DISCLOSURE

This disclosure pertains to electronic commerce. More particularly, this disclosure pertains to a method and system for auctioning bonds using a full-time public network.

### BACKGROUND OF THE DISCLOSURE

Bonds have long lacked the kind of price immediacy that stocks exhibit and require, however, today's alternative trading systems (ATSs) are bidding to deliver much of the transparency of stock markets to bond trading by engineering a real-time, tradable bond ticker. But there are limitations.

Past attempts to bring the price transparency of equity markets to the bond arena initially caused securities regulators to baulk. For larger investors, price transparency may come at the expense of best execution, as transparent price signals make large orders harder to fill. More-rather than full-transparency, is the goal of debt market participants. Why full transparency does not work lies in the unique nature of debt markets. Unlike equity markets, there is no central marketplace for bonds, simply dealers trading out of their own inventory. Until now, there has been no equivalent to the TSX's or NASDAQ's data feeds to provide price discovery.

The cost of trading may also discourage more widespread participation in the bond market, especially among smaller non-institutional investors. Additionally, economic information has already been factored into bond prices to a large extent, making it hard for buyers to gain any kind of informational advantage. Perhaps the most critical difference is the emphasis put on price discovery versus liquidity. Equity investors seek price bargains, while liquidity is perhaps more important in the bond market, especially because retail investors are few.

Much liquidity becomes inherent in the current trader-dealer bond system. For example, two new fixed income issues are floated each week. On the TSX, $12.6 billion worth of new listings debuted in 2004, while on the bond side the federal government alone auctioned off $77.4 billion in new debt. Add to that the regular issuance of short-term notes, such as banker's acceptances and commercial paper, and you have a highly liquid market of buyers and sellers.

Traditionally, bond investors have shopped around by phoning a succession of bond dealers. In so doing, they risked revealing their intentions. With too little transparency, bond investors may not get the best price. With too much transparency, they may not get the best deal, as liquidity dries up and only partial orders are filled. The perceived benefits of transparency also hinge on what side of the market you are on. Institutional investors like anonymity when they're selling, but not when they are buying. Instead, they want to know who they are dealing with. Transparency is just one of a number of complexities inherent to bond trading. Others include liquidity, operational efficiency, risk management, and best execution.

Every system will have some type of pricing or transparency component where the client is getting some view of the marketplace. As that transparency component comes into play, however, risk management becomes crucial, since the spread between bidding and offering prices would widen and dealers would find it harder to hedge their exposure in the futures market. There is a need, accordingly, for a method and system for auctioning bonds using a full-time public network that takes into considerations many of the above limitations.

### BRIEF DESCRIPTION OF THE DRAWINGS

For a more complete understanding of the present disclosure, and the advantages thereof, reference is now made to the following brief descriptions taken in conjunction with the accompanying drawings, in which like reference numerals indicate like features.

FIG. 1 illustrates a general purpose computing system that may be part of a network of such computing systems for employing the method and system for auctioning bonds using a full-time public network in an embodiment of the present disclosure.

FIG. 2 shows the steps of a method for auctioning bonds to a trading house using a full-time public network, in accordance with an embodiment of the present disclosure.

FIG. 3 depicts the components of exemplary trading house criteria, in accordance with an embodiment of the present disclosure.

FIG. 4 overviews a method for auctioning bonds by a trader using a full-time public network, in accordance with an embodiment of the present disclosure.

FIG. 5 characterizes the components of exemplary trader criteria, in accordance with an embodiment of the present disclosure.

FIG. 6 delineates an electronically connected network illustrating an environment capable of supporting the method and system of the present disclosure for auctioning bonds using a full-time public network in an embodiment of the present disclosure.

FIG. 7 represents an auctioneer computing system having several operating modules, in accordance with an embodiment of the present disclosure.

FIG. 8 portrays an overview of an auction process, in accordance with an embodiment of the present disclosure.

FIG. 9 describes a trader-oriented auction process, in accordance with an embodiment of the present disclosure.

FIG. 10 illustrates a standard-term auction process detail, in accordance with an embodiment of the present disclosure.

FIG. 11 overviews establishment of a standing bid by a trading house, in accordance with an embodiment of the present disclosure.

FIG. 12 characterizes differences between an auction process for standard term bond trades and an auction process for custom term bond trades, in accordance with an embodiment of the present disclosure.

FIG. 13 shows a trader process for a standard bond trade auction, in accordance with an embodiment of the present disclosure.

FIG. 14 portrays a trading house process for a standard bond trade auction, in accordance with an embodiment of the present disclosure.

FIG. 15 depicts an auctioneer process for a standard bond trade auction, in accordance with an embodiment of the present disclosure.

FIG. 16 delineates spreading of bonds by a trader across several trading houses, in accordance with an embodiment of the present disclosure.

FIG. 17 represents facilitation of a bond trade auction for a custom term bond trade, in accordance with an embodiment of the present disclosure.

FIG. 18 describes an alternate approach to obtaining similar results to the representation of FIG. 17, in accordance with an embodiment of the present disclosure.

FIG. 19 shows a process for auctioning trading house bond trade opportunities to traders, in accordance with an embodiment of the present disclosure.

### DETAILED DESCRIPTION OF THE DISCLOSURE

The disclosure provides a method and system of auctioning bonds via a full-time public network. Other aspects, objectives and advantages of the disclosure will become more apparent from the remainder of the detailed description when taken in conjunction with the accompanying drawings. One consequence of employing the present disclosure is that commission charges could be reduced, while still leaving room for profit, from three to five basis points often charged by bond brokers to each party to the transaction, to a level of one to two basis points charged only to the trading house receiving a bond trade. That is, many embodiments of the present disclosure will reduce costs dramatically from the current trading house-to-trading house trading paradigm by providing a technical solution that allows intermediary expense-generating activities between trader and trading house to be reduced.

In addition to reducing costs, it can be anticipated that optimal implementation of embodiments of the present disclosure could reduce the necessary flow of bonds from $4 trillion daily to $1 trillion daily. This would essentially reduce the velocity of trading house-to-trading house money by a factor of four. In addition to the cost benefit to individual traders and trading houses, this would provide significant macroeconomic benefit.

A further potential benefit of many embodiments of the present disclosure is that the traders and trading houses having been matched to each other would have reason to enjoy improved confidence that transaction execution has been satisfactory. This differs from current practice in which only the broker between the trader and trading house truly knows the quality of execution.

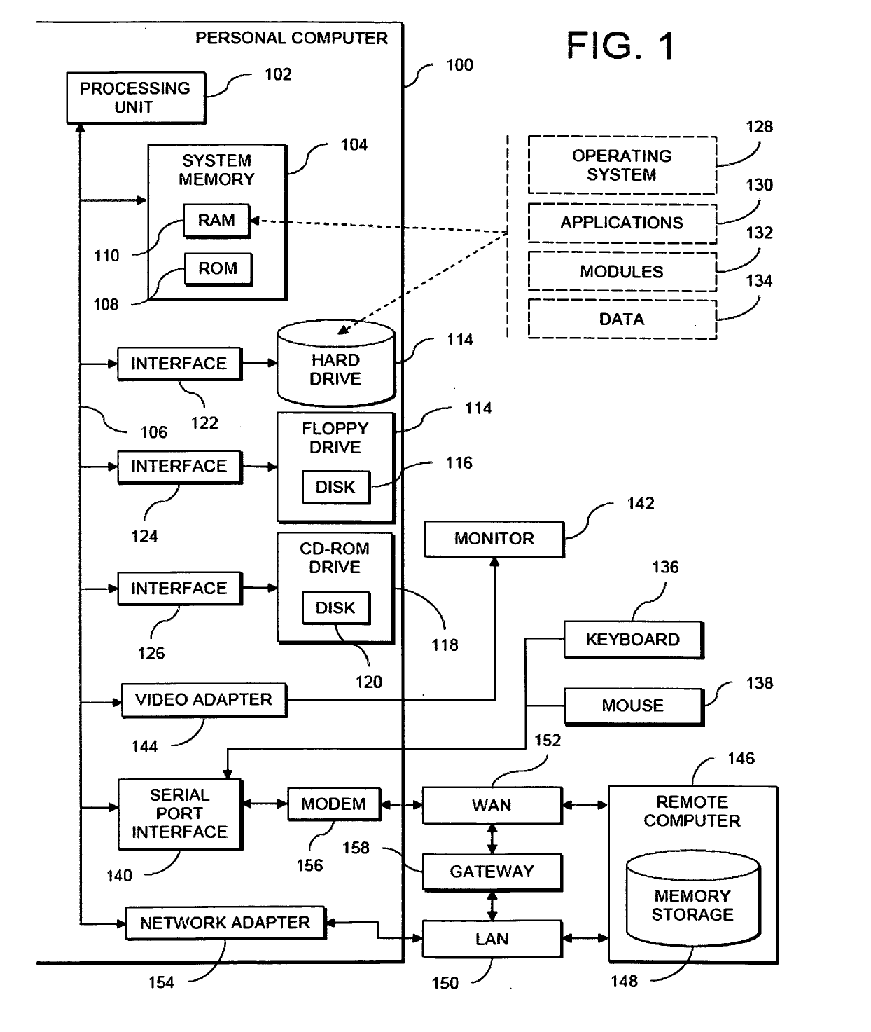

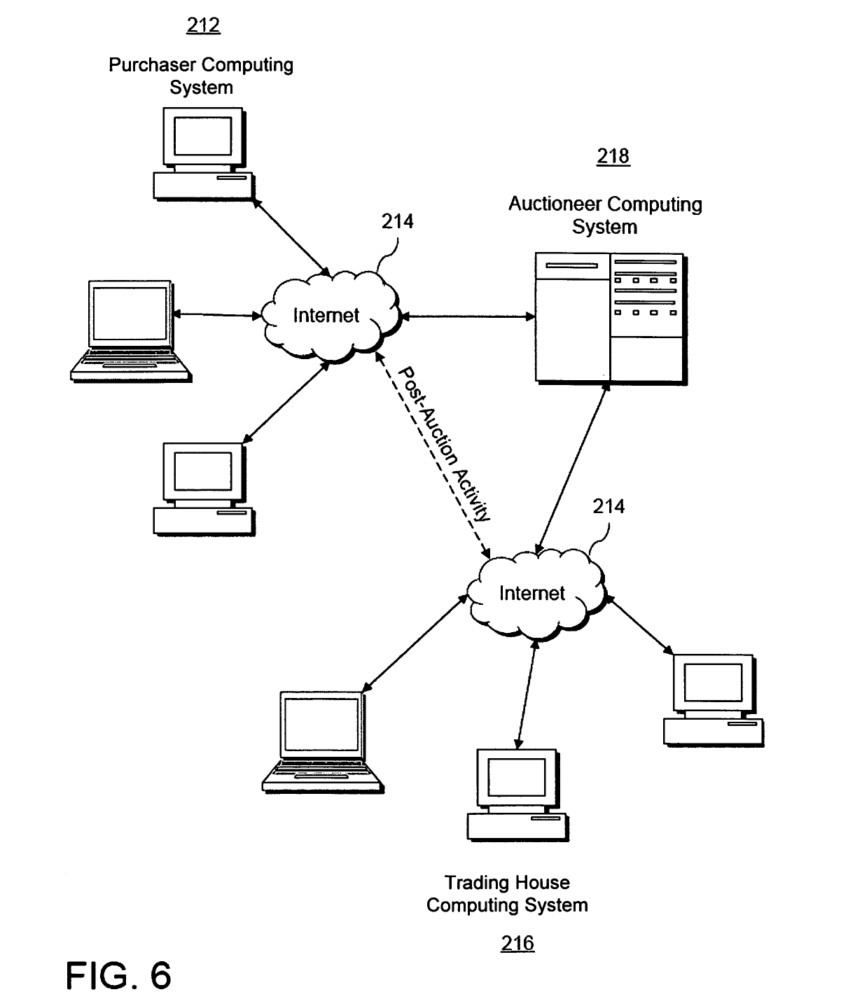

FIG. 1 illustrates a general purpose computing system that may be part of a network of such computing systems for employing the present disclosure's method and system for auctioning bonds using a full-time public network. By associating a network of general-purpose computers 100, an example of which appears below in FIG. 6, the present disclosure facilitates automatic on-line matching of transactions using an auction-based protocol over a full-time public network. In such an electronic conveyancing environment as established by the present disclosure, at least two such computers may be operated at different locations within a given geographical or similarly bounded area.

With reference to FIG. 1, general-purpose computer 100 may be a personal computer, a laptop, palmtop, or other set top, server, mainframe, and other variety computer, and include processing unit 102, system memory 104, and system bus 106 coupling various system components including system memory 104 to the processing unit 102. Processing unit 102 may be any of various commercially available processors, including Intel x86, Pentium® and compatible microprocessors from Intel® and others, including Cyrix®, AMD® and Nexgen®; MIPS® from MIPS Technology®, NEC®, Siemens®, and others; and the PowerPC® from IBM and Motorola. Dual microprocessors and other multi-processor architectures also can be used as the processing unit 102. System bus 106 may be any of several types of bus structures including a memory bus or memory controller, a peripheral bus, and a local bus using any of a variety of conventional bus architectures such as PCI, VESA, AGP, Microchannel, ISA and EISA, to name a few. System memory 104 includes read only memory (ROM) 108 and random access memory (RAM) 110. A basic input/output system (BIOS), containing the basic routines helping to transfer information between elements within the computer 100, such as during start-up, is stored in ROM 108.

Computer 100 further includes a hard disk drive 112, a floppy drive 114, e.g., to read from or write to a removable disk 116, and CD-ROM drive 118, e.g., for reading a CD-ROM disk 120 or to read from or write to other optical media. The hard disk drive 112, floppy drive 114, and CD-ROM drive 118 are connected to the system bus 106 by a hard disk drive interface 122, a floppy drive interface 124, and an optical drive interface 126, respectively. The drives and their associated computer-readable media provide nonvolatile storage of data, data structures, computer-executable instructions, etc., for computer 100. Although the description of computer-readable media provided above refers to a hard disk, a removable floppy and a CD, those skilled in the art may appreciate other types of media which are readable by a computer, such as magnetic cassettes, flash memory cards, digital video disks, Bernoulli cartridges, and the like, being used in the exemplary operating environment.

A number of program modules may be stored in the drives and RAM 110, including an operating system 128, one or more application programs 130, other program modules 132, and program data 134. A consumer may enter commands and information into the computer 100 through a keyboard 136 and pointing device, such as mouse 138. Other input devices (not shown) may include a microphone, joystick, game pad, satellite dish, scanner, or the like. These and other input devices are often connected to the processing unit 102 through a serial port interface 140 coupling to the system bus, but possibly connecting by other interfaces, such as a parallel port, game port or a universal serial bus (USB). A monitor 142 or other type of display device is also connected to the system bus 106 via an interface, such as a video adapter 144. In addition to the monitor, computers typically include other peripheral output devices (not shown), such as speakers and printers.

Computer 100 may operate in a networked environment using logical connections to one or more remote computers, such as a remote computer 146. Remote computer 146 may be a server, a router, a peer device or other common network node, and typically includes many or all of the elements described relative to the computer 100, although only a memory storage device 148 has been illustrated in FIG. 1. The logical connections depicted in FIG. 1 include a local area network (LAN) 150 and a wide area network (WAN) 152. Such networking environments are commonplace in offices, enterprise-wide computer networks, intranets and the Internet.

When used in a LAN networking environment, the computer 100 is connected to the LAN 150 through a network interface or adapter 154. When used in a WAN networking environment, computer 100 typically includes a modem 156 or other means for establishing communications (e.g., via the LAN 150 and a gateway or proxy server) over the wide area network 152, such as the Internet. Modem 156, which may be internal or external, is connected to the system bus 106 via the serial port interface 140. In a networked environment, program modules depicted relative to the computer 100, or portions thereof, may be stored in the remote memory storage device 148.

Those skilled in the art may appreciate the network connections shown as being exemplary, wherein other means of establishing a communications link between the computers may be used. FIG. 1 only provides one example of a computer useful for employing the teachings of the present disclosure. The disclosure may be used in computers other than general-purpose computers, as well as on general-purpose computers without conventional operating systems.

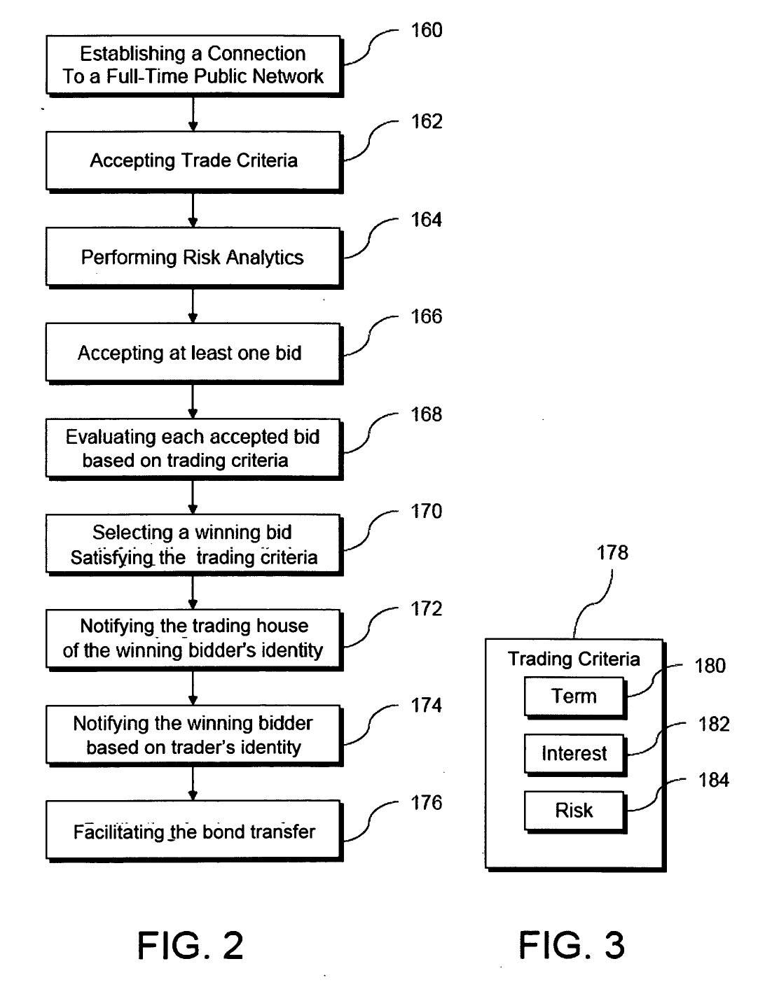

FIG. 2 depicts a method for auctioning bonds to a trading house using a full-time public network, including several steps. A connection is established 160 to a full-time public network. Trading house criteria received via the full-time public network is accepted 162. Risk analytics is performed 164 to facilitate identification of acceptable bidders. At least one bid is accepted 166 from at least one acceptable bidder via the full-time public network. Each accepted bid is evaluated 168 based on the trading house criteria to determine whether the bid satisfies the criteria. At least one bid is selected 170 as a winning bid determined to satisfy the trading house criteria. The trading house is notified 172 of the winning bidder's identity. The winning bidder is notified 174 of the trading house's identity. The transfer of bonds from the winning bidder to the trading house is facilitated 176 according to the terms of the trading house criteria and the winning bid.

FIG. 3 depicts the components of exemplary trading house criteria 178, in accordance with an embodiment of the present disclosure. The trading house criteria 178 include a term 180, a range of acceptable interest rates 182, and information pertaining to acceptable risk 184. The identity of all participants can be maintained as confidential during the auction. This can provide value to the participants who do not wish others to know of their auction participation activities. For example, trading houses often have a vested interest in keeping auction activity confidential from competing institutions as proprietary business information. This process reasonably protects the anonymity of all parties involved. Accordingly, this market mechanism can offer complete anonymity to all participants until such time as there is a winning bid. None of the participating trading houses will know what other participating trading houses (i.e., competitors) are offering to win bids. Moreover, participating trading houses will be unaware of which participant is winning a given auction, which may benefit traders by translating into higher interest rates paid.

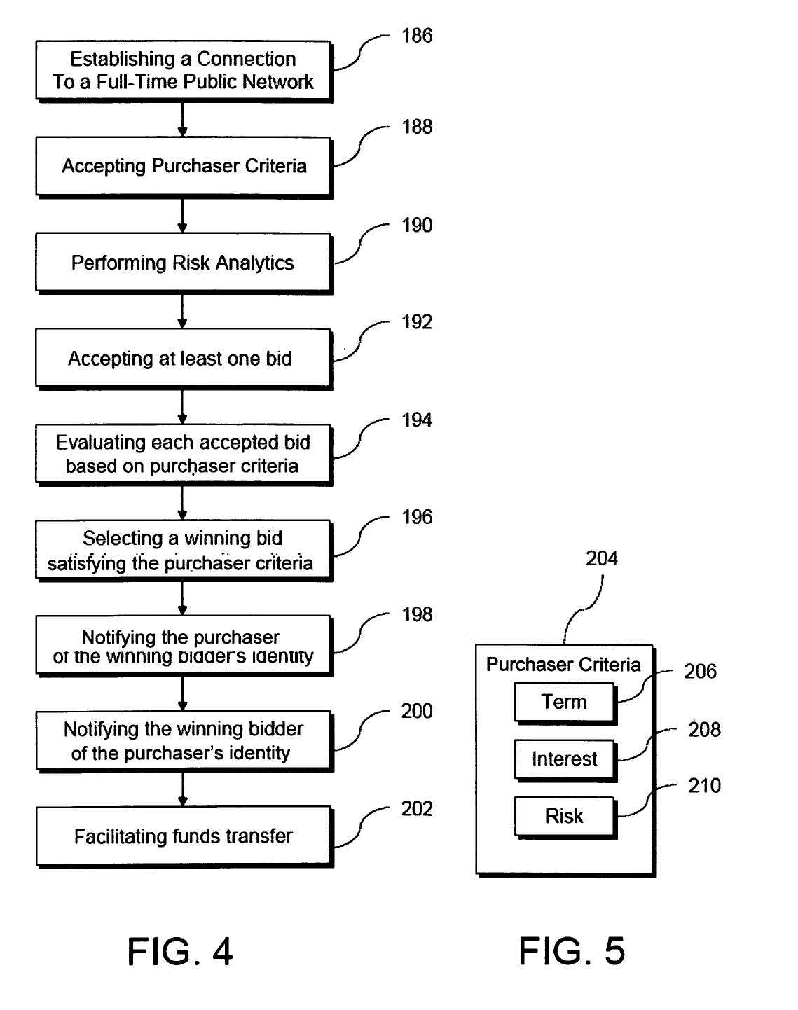

FIG. 4 depicts a method for auctioning bonds by a trader using a full-time public network, including several steps. A connection is established 186 to a full-time public network. Trader criteria received via the full-time public network is accepted 188. Risk analytics is performed 190 to facilitate identification of acceptable bidders. At least one bid is accepted 192 from at least one acceptable bidder via the full-time public network. Each accepted bid is evaluated 194 based on the trader criteria to determine whether the bid satisfies the criteria. At least one bid is selected 196 as a winning bid determined to satisfy the trader criteria. The trader is notified 198 of the winning bidder's identity. The winning bidder is notified 200 of the trader's identity. The transfer of bonds from the trader to the winning trading house is facilitated 202 according to the terms of the trader criteria and the winning bid.

FIG. 5 depicts the components of exemplary trader criteria 204, in accordance with an embodiment of the present disclosure. The trader criteria 204 includes a term 206, a range of acceptable interest rates 208, and information pertaining to acceptable risk 210. Some embodiments allow the bond trade criteria to be non-standard compared to typical industry practices, in which case member trading houses may be apprised of the non-standard bond trade criteria.

For example, standard bond trade criteria could include terms divisible by 30 days, such as 30 days, 60 days, 90 days, etc. If so, bond trade criteria specifying 45 days would be non-standard. In addition, the step of accepting at least one bid from at least one acceptable bidder via the full-time public network may include reviewing at least one unfulfilled standing bid to determine whether the unfulfilled standing bid satisfies the bond trade criteria and automatically accepting unfulfilled standing bids that satisfy the bond trade criteria.

FIG. 6 delineates an electronically connected network illustrating an environment capable of supporting the method and system of the present disclosure for auctioning bonds using a full-time public network in an embodiment of the present disclosure. The system of FIG. 6 for auction-based transactional matching of traders and trading houses in order to achieve qualified placement of bonds so as to satisfy the criteria of trader and trading house has several components. The system includes at least one trader computing system 212 adapted to communicably couple to an auctioneer computing system 218 via the full-time public network 214. The system also includes at least one trading house computing system 216 adapted to communicably couple to the auctioneer computing system 218 via the full-time public network 214.

Furthermore, as shown in FIG. 6, the at least one trader computing system 212 is adapted to communicably couple to the at least one trading house computing system 216 following conclusion of the auction-based match in order to execute post-auction activity in accordance with the terms of the trader criteria and the trading house criteria.

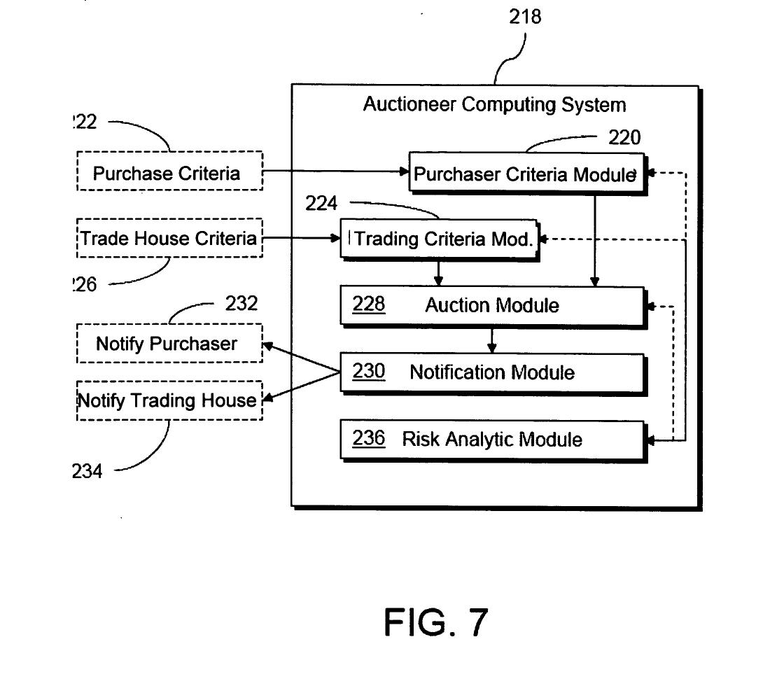

FIG. 7 represents the auctioneer computing system 218 having several operating modules, in accordance with an embodiment of the present disclosure. A trader criteria module 220 is adapted to accept trader criteria 222 from potential traders via the full-time public network. A trading house criteria module 224 is adapted to accept trading house criteria 226 from potential traders via the full-time public network. An auction module 228 is adapted to perform an auction-based transactional matching of accepted trader criteria to accepted trading house criteria, wherein each criteria satisfies the requirements of the criteria to which it is matched. A notification module 230 is adapted to notify, in response to the matching of an accepted trader criteria with an accepted trading house criteria, the corresponding trader 232 and the corresponding trading house 234 of the match via the full-time public network.

The auctioneer computing system of FIG. 7 may further include a risk analytic module 236 adapted to perform risk analytics on accepted trader criteria 222 and accepted trading house criteria 226 in order to facilitate matching. The risk analytic module may include computer-readable instructions, the execution of which causes performance of risk analytics on accepted trader criteria 222 and accepted trading house criteria 226 in order to facilitate matching.

The trader criteria module 220 shown in FIG. 7 may include computer-readable instructions, the execution of which causes acceptance of trader criteria 222 from potential traders via the full-time public network. The trading house criteria module 224 may include computer-readable instructions, the execution of which causes acceptance of trading house criteria 226 from potential traders via the full-time public network.

The auction module 228 may include computer-readable instructions, the execution of which causes performance of an auction-based transactional matching of accepted trader criteria 222 to accepted trading house criteria 226, wherein each criteria satisfies the requirements of the criteria to which it is matched.

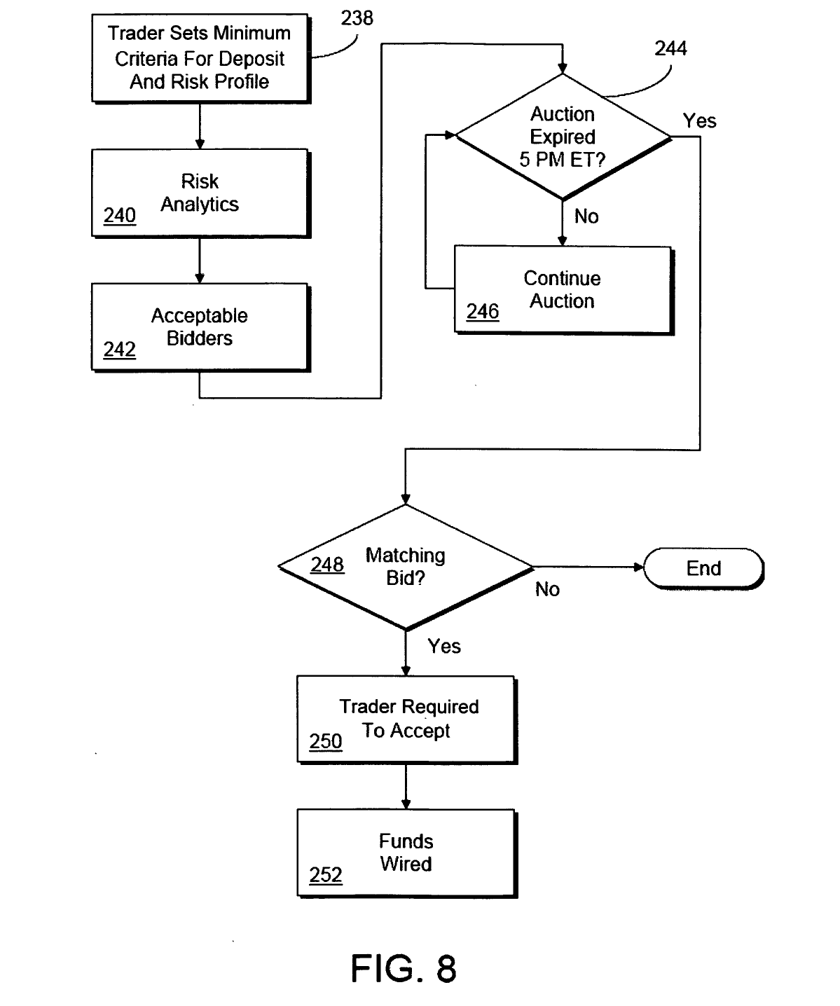

FIG. 8 portrays an overview of an auction process, in accordance with an embodiment of the present disclosure. Initiating the process, a trading house sets minimum criteria 238 in order to establish a bond trade and risk profile. Risk analytics are performed 240 in order to facilitate matching of the bond trade and risk profile of the trading house to trader bids. Acceptable bidders are allowed to bid 242 on the trading house profile so long as the auction is not expired, typically at 5 p.m. Eastern Time 244. The auction continues 246 until it expires. If no matching bids 248 are forthcoming, the auction process ends without a match having been made. Otherwise, the trading house is required to accept 250 the winning trader's bid, and the trader's bonds are wired 252 to the trading house.

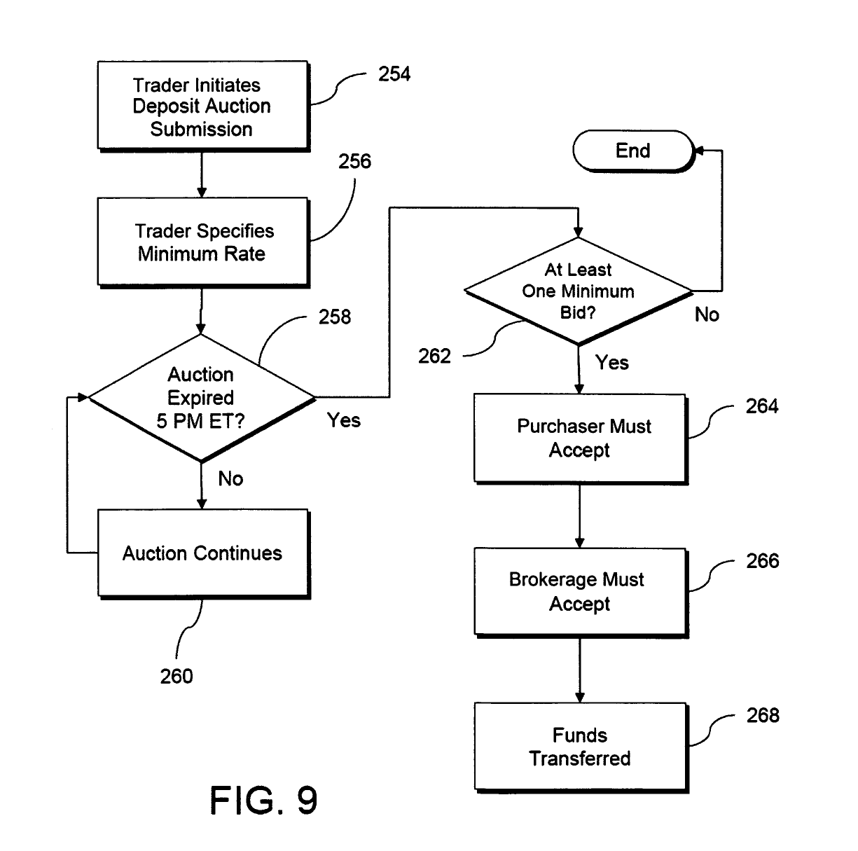

FIG. 9 describes a trader-oriented auction process, in accordance with an embodiment of the present disclosure. Initially, a trading house initiates 254 a bond trade auction submission. Subsequently, the trading house specifies a minimum acceptable rate of interest 256 for the bond itself. So long as the auction is unexpired 258, the auction continues 260. Once the auction has expired, if there has not been at least one minimum bid 262, the auction ends without a match. Otherwise, the trader must accept 264 the winning trading house bid. Likewise, the winning trading house must accept 266 the terms of its bid. Subsequently the trader's bonds are transferred 268 to the winning trading house.

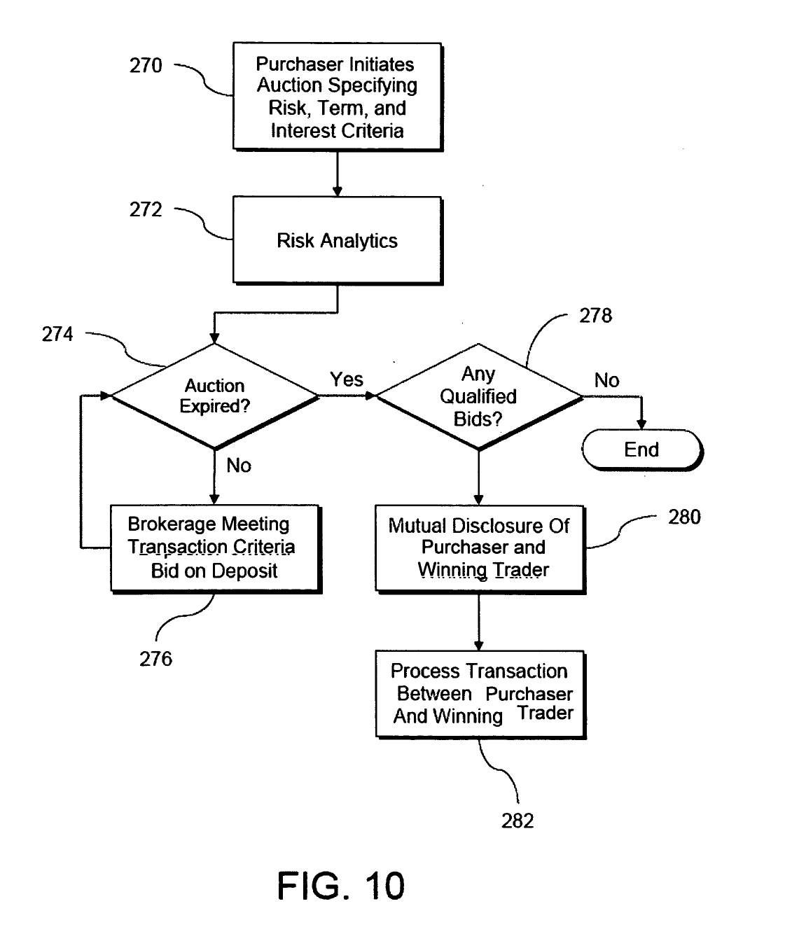

FIG. 10 illustrates a standard-term auction process detail, in accordance with an embodiment of the present disclosure. A trader initiates 270 the auction, specifying all relevant criteria, including acceptable risk information, terms, and interest rate range. Risk analytics 272 are performed to facilitate suitable matching of trader and trading house. So long as the auction is unexpired 274, trading houses meeting 276 the trader criteria are able to bid on the bond trade being auctioned. Upon expiration of the auction, if no qualified bids have been entered 278, the auction ends without having matched the trader to a trading house. Otherwise, mutual disclosure of identity occurs 280 between the trader and the winning trading house. Until that time, the identity of the bond trade poster and the identity of the bidding trading houses remains confidential. Finally, the transaction between the trader and the winning trading house is processed 282.

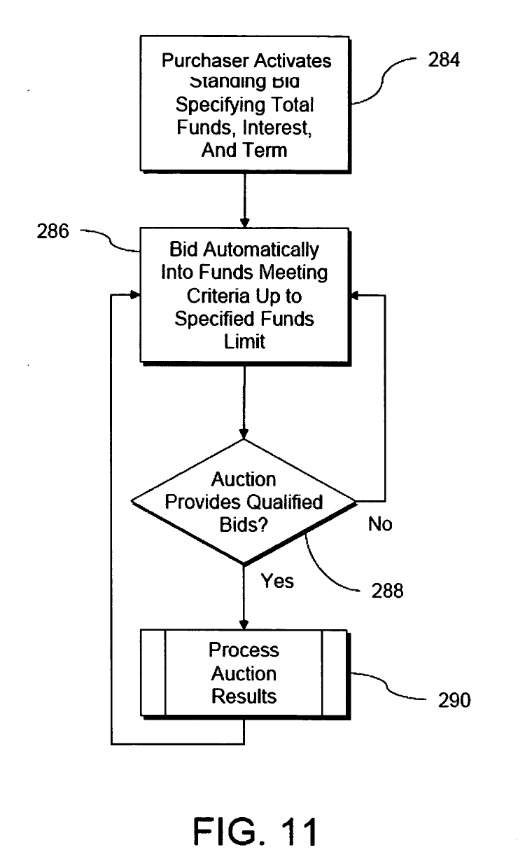

FIG. 11 overviews establishment of a standing bid by a trading house, in accordance with an embodiment of the present disclosure. A trading house activates 284 a standing bid, specifying the total amount of bonds being sought, acceptable interest rate limitations, and term. The standing bid causes the trading house to bid automatically 286 into trader bonds being auctioned which meet the trading house's standing bid criteria up to the specified limitation of trading house bonds available for satisfying the standing bid. If the auction does not provide 288 qualified bids, the standing bid continues to cause the trading house to bid automatically 286 into trader bonds being auctioned which meet the trading house's standing bid criteria up to the specified limitation of trading house bonds available for satisfying the standing bid. If the auction does provide 288 a qualified bid, then the auction results are processed 290, the specified limitation of trading house bonds available for satisfying the standing bid is revised downward an amount corresponding to the winning bid, and, if trading house bonds remain available to satisfy the standing bid, the standing bid causes the trading house to bid automatically 286 into trader bonds being auctioned which meet the trading house's standing bid criteria up to the remaining limitation of trading house bonds available for satisfying the standing bid.

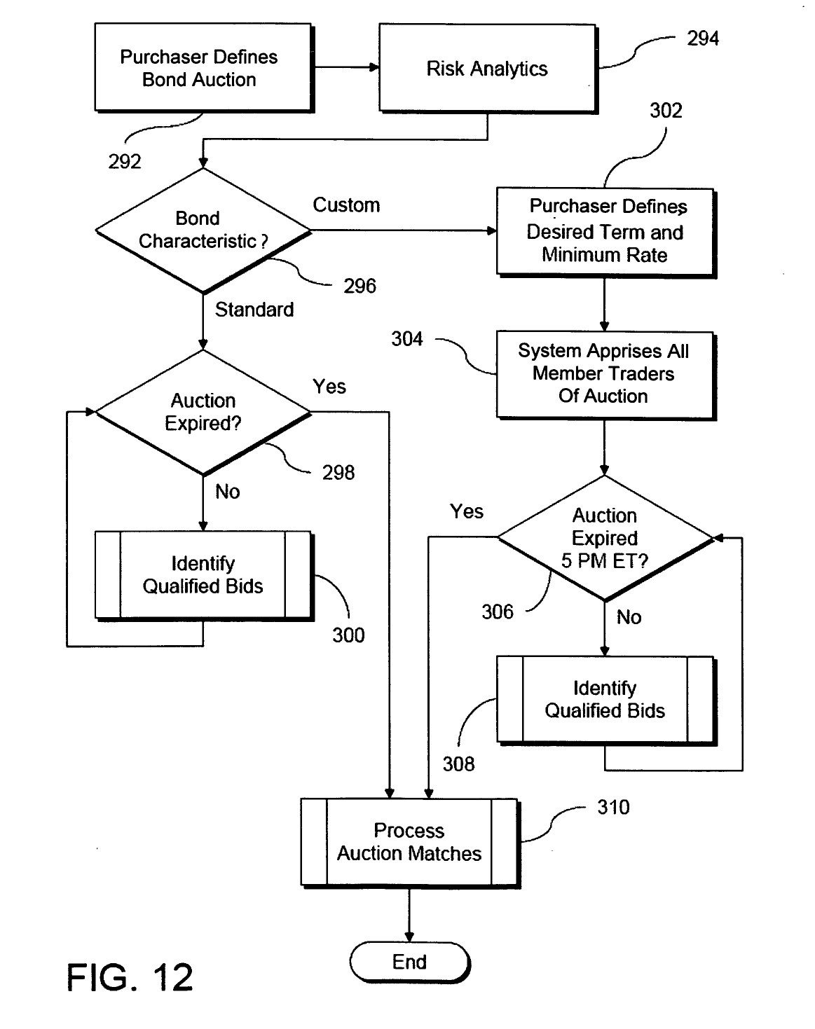

FIG. 12 characterizes differences between an auction process for standard term bond trades and an auction process for custom term bond trades, in accordance with an embodiment of the present disclosure. A trader defines 292 a bond trade auction. Risk analytics are performed 294 to facilitate matching. If the bond trade characteristics are standard 296, then so long as the auction is unexpired 298, qualified bids are identified 300. Once the auction expires 298, auction matches are processed 310.

If, in FIG. 12, the bond trade characteristics are custom 296, i.e., non-standard, the trader defines 302 a desired term and minimum interest rate. The system then apprises 304 all member trading houses of the auction, so the member trading houses can formulate bids, if desired. While the auction lasts 306, qualified bids are identified 308. Upon completion of the auction 306, auction matches are processed 310.

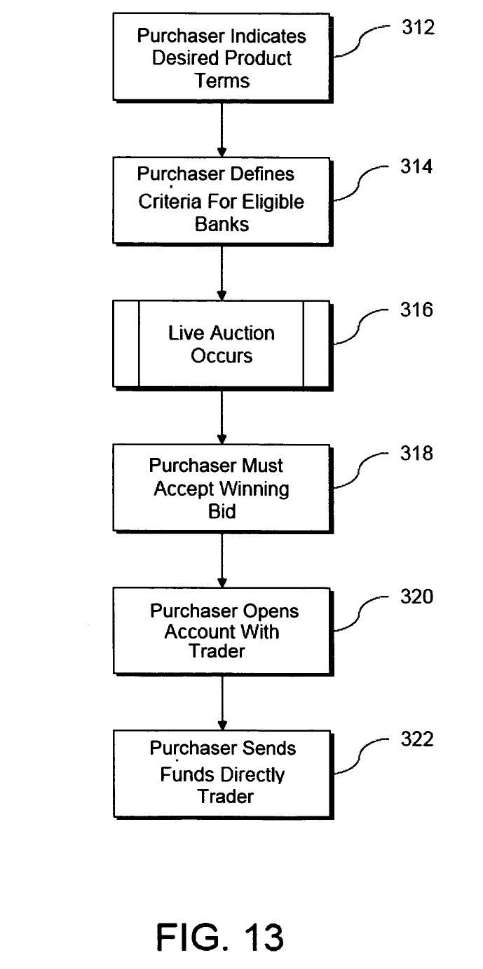

FIG. 13 shows a trader process for a standard bond trade auction, in accordance with an embodiment of the present disclosure. The trader indicates 312 desired product terms. The trader defines 314 criteria for eligible trading houses. A live auction then occurs 316, resulting in a match. The trader must accept 318 the winning bid. The trader consequently opens an account 320 with the winning trading house, and the trader sends 322 corresponding bonds directly to the winning trading house.

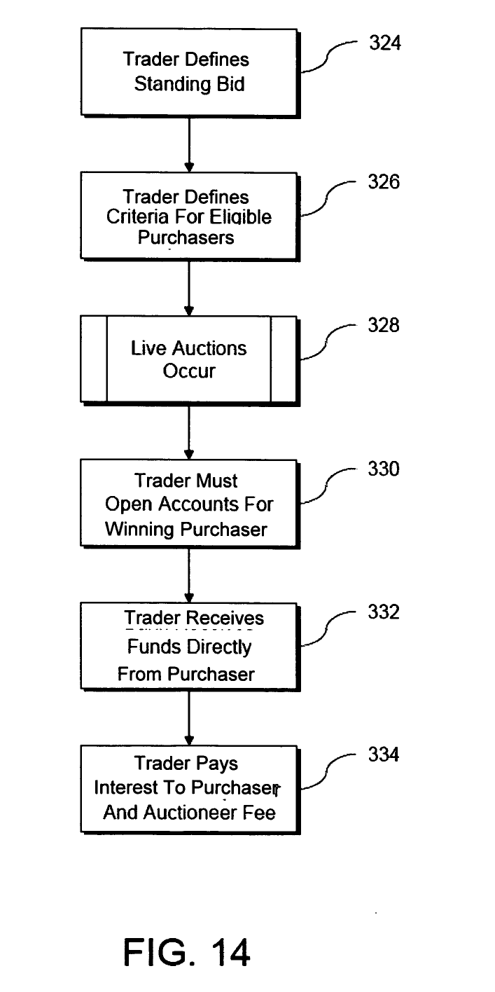

FIG. 14 portrays a trading house process for a standard bond trade auction, in accordance with an embodiment of the present disclosure. The trading house defines 324 a standing bid. The trading house defines 326 criteria for eligible traders. For example, the trading house may wish to avoid cannibalizing customers from its retail trading house branches in specific geographic areas. In that case, traders in those geographic areas will not be eligible to bid. The live auction occurs 328, resulting in a match. The trading house must open accounts 330 for the winning trader. The trading house receives bonds 332 directly from the trader. Finally, the trading house pays interest 334 to the trader and an auctioneer fee to the auctioneer.

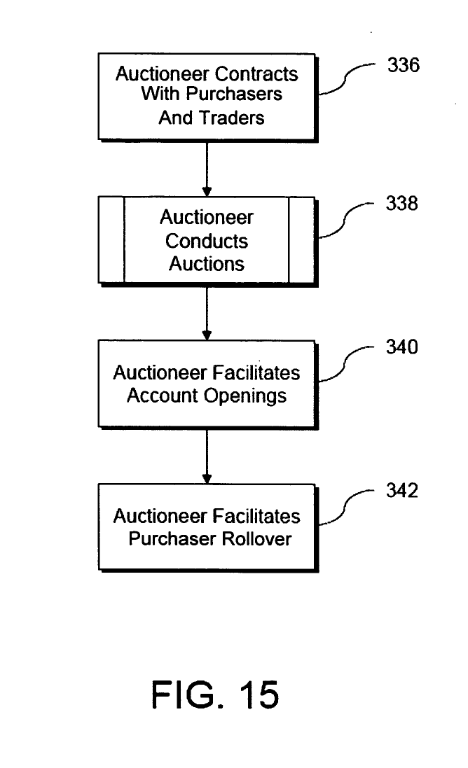

FIG. 15 depicts an auctioneer process for a standard bond trade auction, in accordance with an embodiment of the present disclosure. An auctioneer contracts 336 with traders and trading houses, binding each to accept resulting matches that meet the auctioning party's defined criteria and that meet the bidding party's bid terms. The auctioneer then conducts 338 auctions, after the successful conclusion of which, the auctioneer facilitates 340 account openings and facilitates 342 trader rollovers.

The following examples further illustrate the disclosure but, of course, should not be construed as in any way limiting its scope.

### EXAMPLE 1

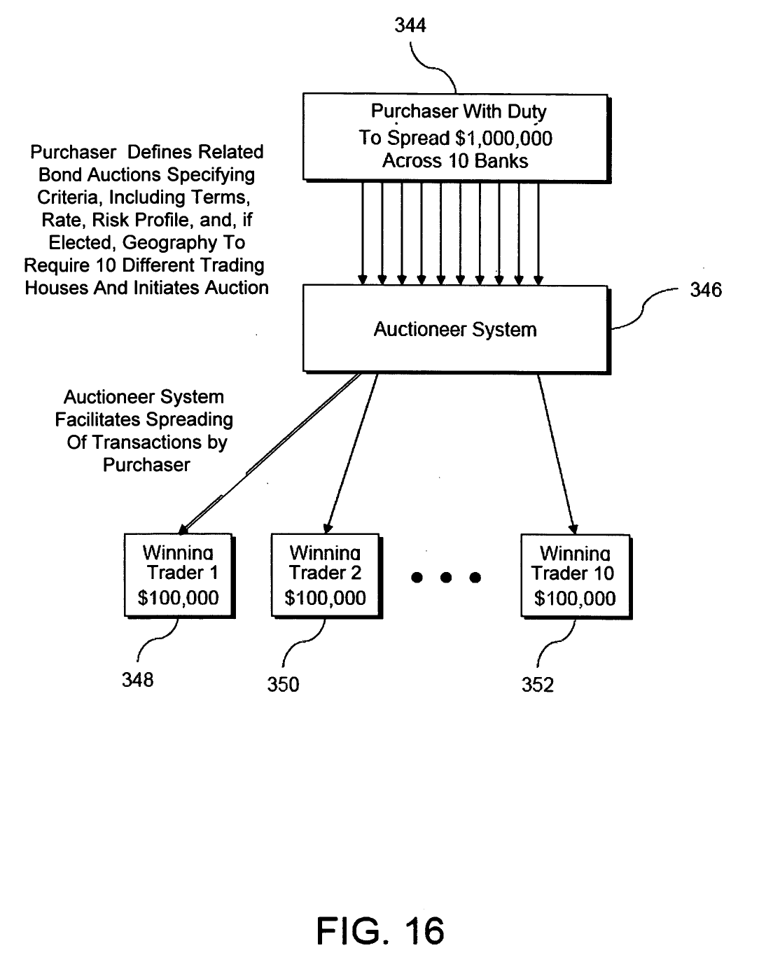

FIG. 16 delineates spreading of bonds by a trader across several trading houses, in accordance with an embodiment of the present disclosure. This is but one example of the ability of the claimed method and system of the present disclosure to meet the customized needs of particular traders and particular trading houses. In this example, a trader has $1,000,000 for a bond trade. The trader also has a duty to spread these bonds across ten trading houses. While there are many alternate approaches the trader could use within the claimed method and system of the present disclosure in order to achieve this result, in FIG. 16, the trader elects to define related bond trade auctions, specifying corresponding criteria, including terms, rate, risk profile to require ten different trading houses to match the bond trades, so that no two bond trades would need to be made with the same trading house. Note that the trader would also have the option of specifying geography or any other relevant characteristic of the bond trade that the trader desired to make part of the bond trade criteria. The auctioneer system 346 makes the appropriate matches, if appropriate trading house bids are forthcoming, matching the bonds in $100,000 increments, as specified by the trader, to ten trading houses 348, 350, . . . , and 352.

### EXAMPLE 2

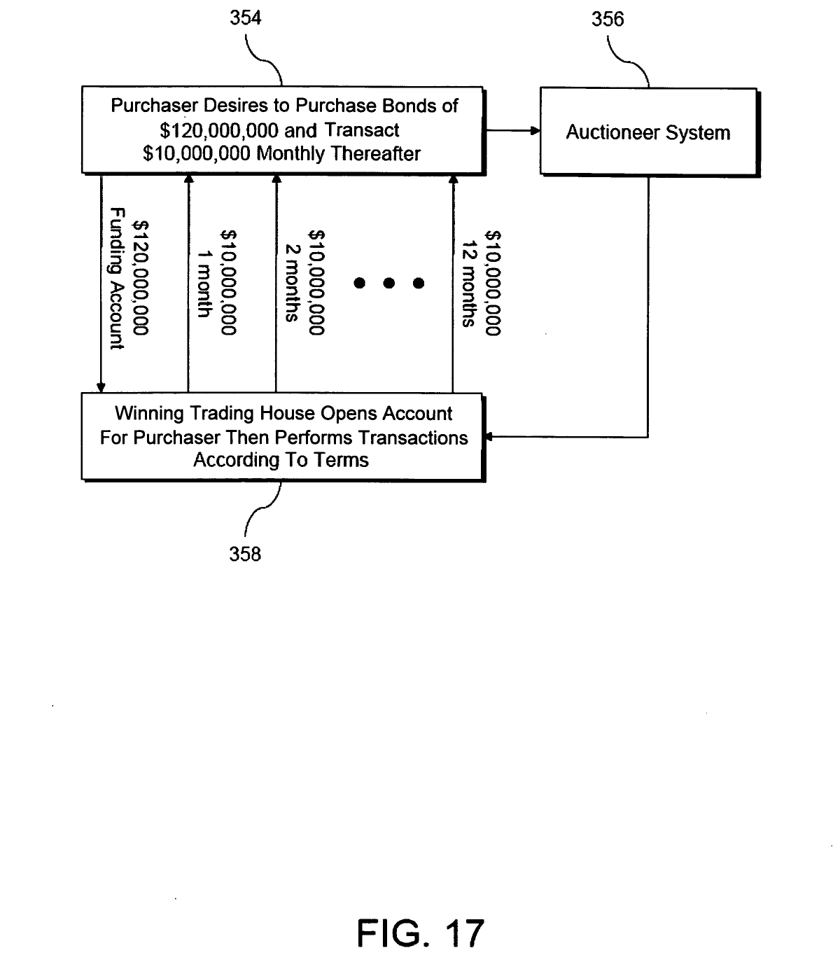

FIG. 17 represents facilitation of a bond trade auction for a custom term bond trade, in accordance with an embodiment of the present disclosure. This shows a second example: one in which the trader 354 wishes to place $120,000,000 with a single trading house and receive back 1/12th of that amount each month for 12 months. The trader defines the custom bond trade criteria, and the auctioneer system 356 processes the auction accordingly. If a winning bid is ascertained, the winning trading house 358 opens an account for the trader and then disburses the bonds according to the specified terms of the bond trade criteria and the winning bid. Therefore, the trader would first fund the account with $120,000,000. Subsequently, the trading house would make a monthly transfer of $10,000,000 to the trader.

### EXAMPLE 3

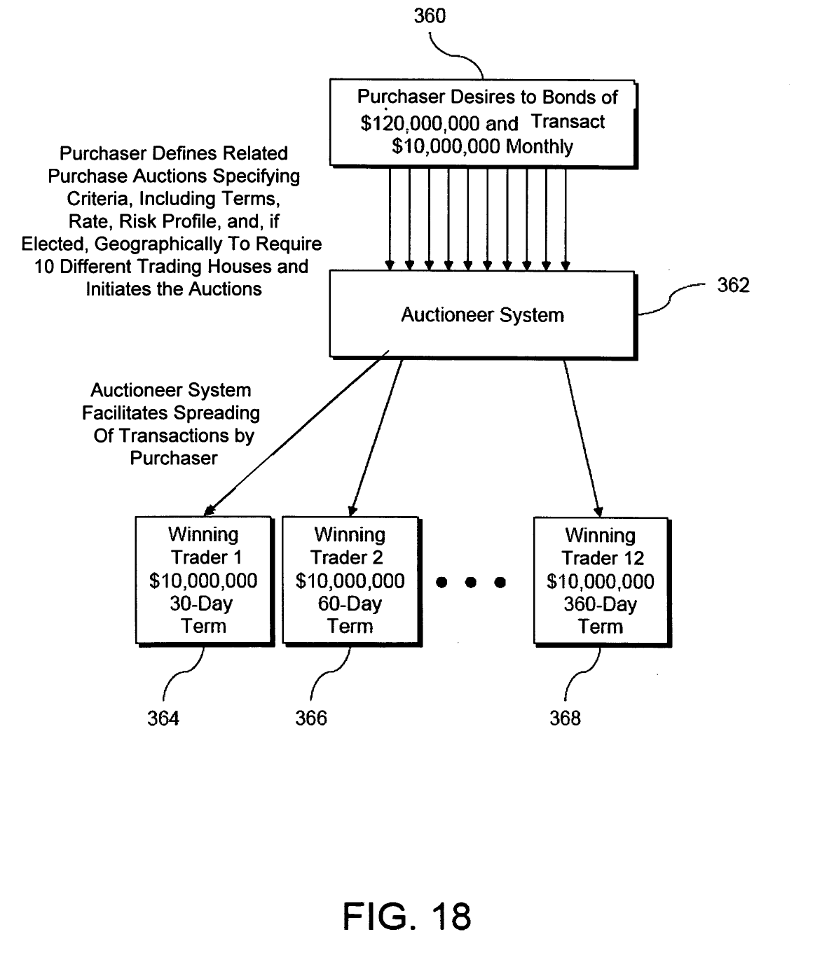

FIG. 18 describes an alternate approach to obtaining similar results to the representation of FIG. 17, in accordance with an embodiment of the present disclosure. In this third example, the trader 360 not only desires to place a single bond trade for $120,000,000 and receive back 1/12^{th} each month, but also wishes to place no more than $10,000,000 with any single trading house. Therefore, the trader 360 defines the custom bond trade criteria accordingly, and that auctioneer system 362 processes the auction. If corresponding matches are made with twelve trading houses 364, 366, . . . , and 368, auctioneer system 362 processes the matches accordingly, requiring the trader and trading houses to close the transactions in accordance with the terms of the bond trade criteria and relevant bids.

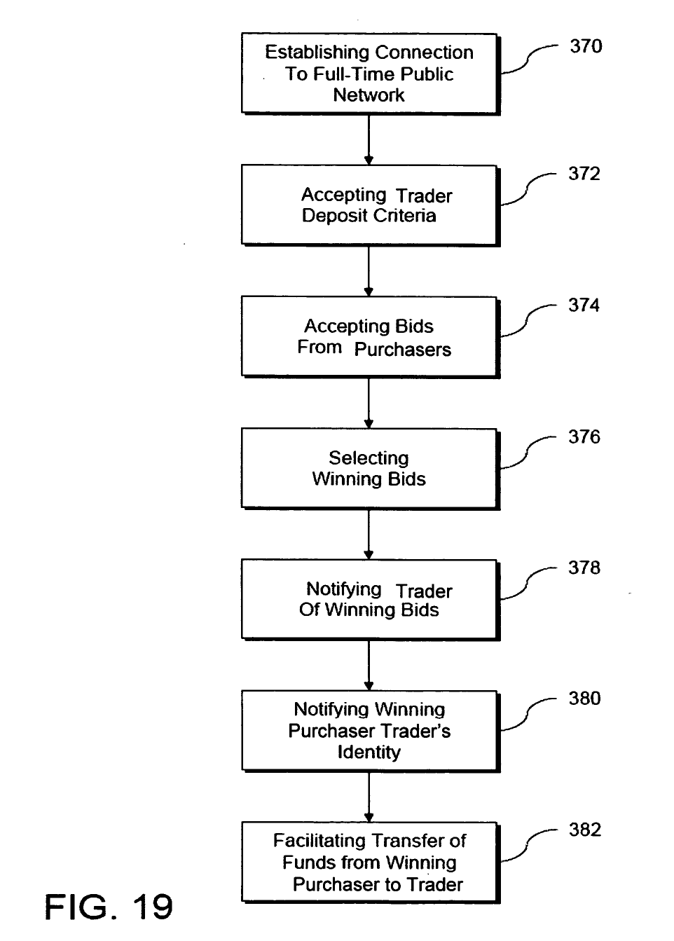

FIG. 19 shows a method for auctioning trading house bond trade opportunities to traders using a full-time public network. In the shown embodiment, the trading house establishes a connection to a full-time public network is established 370. Trading house bond trade criteria are accepted 372 from the trading house via the full-time public network. The bond trade criteria include a bond trade amount, bond trade terms, and a maximum specified interest rate. At least one bid is accepted 374 from at least one trader via the full-time public network, the bid including a bid interest rate no more than the maximum specified interest rate. At least one winning bid is selected 376 from the accepted bids on the basis of its bid interest rate. The trading house is notified 378 of the winning bid, including the identity of the winning bidder and the winning bid interest rate. The winning trader can be notified 380 of the trading house's identity. The transfer of bonds from the winning trader to the trading house can be facilitated 382 to fulfill the trading house bond trade opportunity according to the terms of the trading house bond trade criteria and the winning bid.

The process depicted in FIG. 19 allows each trading house that wishes to attract new traders through the auction process to daily post a standing maximum bid for all standard bond trade products and specify total maximum bonds desired in each maturity category, as well as any desired geographic limitations and a selected maximum interest rate. When a trader indicates a desire to offer bonds via the auction process, the network will automatically notify the trading houses meeting the trader's criteria and commence an automated auction with the trader's bonds being rewarded to the winning bidder. If there is a tie, the trader selects the winning trading house.

### Risk Analytics

Several disclosed embodiments, and some claims, of the present disclosure specify the utilization of risk analytics. Common quantitative factors used in risk analytics include return on assets (ROA), return on equity (ROE), net income, assets, bond trades, other liabilities, and equity. In the case of multi-trading house holding companies, aggregate values can be computed to include all underlying trading house data in the risk analysis.

Going beyond quantitative ratios, a revenue profile can be helpful in performing risk analytics, often including determination of interest income, securities interest income, other interest income, and non-interest and fee income. A balance sheet profile can also be valuable, including assets, liabilities, and equity. Trading house liabilities typically include domestic bond trades, foreign bond trades, fed bonds purchased, repos purchased, trading liabilities, and other liabilities.

For risk analytic purposes, trading house assets are typically divided between bond and lease assets and other assets. Bond assets typically include agriculture bonds, commercial and industrial bonds, real estate bonds, municipal bonds, foreign government bonds, trade institution bonds, commercial real estate bonds, and other types of miscellaneous bonds.

All references, including publications, patent applications, and patents, cited herein are hereby incorporated by reference to the same extent as if each reference were individually and specifically indicated to be incorporated by reference and were set forth in its entirety herein. The use of the terms “a” and “an” and “the” and similar referents in the context of describing the disclosure (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context. For example, the disclosure refers to trading house-to-trading house transactions, but one of skill in the art would appreciate that the inventor intends that the traders referred to in the disclosure and the claims may be a business. Likewise, those having skill in the relevant art would appreciate that the trader could be a consumer. Therefore, the phrase “trading house-to-trading house” as used herein includes “trading house-to-trading house,” “business-to-trading house,” and “consumer-to-trading house.” Similarly, the term “trading house” as used herein can mean “commercial trading house,” “savings trading house,” or other “trading house.” Furthermore, trader criteria can include, for example, $ amount, product term, product timeframe, qualifications of bidding trading houses (such as size, capital, demographics, U.S., foreign, etc.), insured vs. uninsured bond trades, and time for close of bid. Similarly, trading house criteria can include, for example, $ amount, product term, product timeframe, qualifications for potential traders (such as demographics, U.S., foreign, etc.), maximum rate to be paid, and insured vs. uninsured bond trades.

Throughout this disclosure, the auction process has the potential to arrive at a single winning bid. In some embodiments, part of that process may include the selection of a winning bid by the auction initiator, when the auction process has identified more than one winning bid. For example, in some embodiments, if a trader initiates a bond trade auction, and the auctioneer produces more than one winning trading house, the trader then chooses between the winning trading houses where it will bond trade its bonds.

What is claimed is:

1. A method for auctioning bonds to a trading house using a full-time public network, including the steps of:
establishing a connection to a full-time public network;
accepting trading house criteria received via the full-time public network;
performing risk analytics to facilitate identification of acceptable bidders;
accepting at least one bid from at least one acceptable bidder via the full-time public network;
evaluating each accepted bid based on the trading house criteria to determine whether the bid satisfies the criteria; and
selecting as a winning bid at least one bid determined to satisfy the trading house criteria.

2. The method of claim 1, further including the steps of:
notifying the trading house of the winning bidder's identity; and
notifying the winning bidder of the trading house's identity.

3. The method of claim 2, further including the step of:
facilitating the transfer of bonds from the winning bidder to the trading house according to the terms of the trading house criteria and the winning bid.

4. The method of claim 1, wherein the trading house criteria includes a term.

5. The method of claim 1, wherein the trading house criteria includes a range of acceptable interest rates.

6. The method of claim 1, wherein the trading house criteria includes information pertaining to acceptable risk.

7. A method for auctioning bonds by a trader using a full-time public network, including the steps of:
establishing a connection to a full-time public network;
accepting trader criteria received via the full-time public network;
performing risk analytics to facilitate identification of acceptable bidders;
accepting at least one bid from at least one acceptable bidder via the full-time public network;
evaluating each accepted bid based on the trader criteria to determine whether the bid satisfies the criteria; and
selecting as a winning bid at least one bid determined to satisfy the trader criteria.

8. The method of claim 7, further including the steps of:
notifying the trader of the winning bidder's identity; and
notifying the winning bidder of the trader's identity.

9. The method of claim 8, further including the step of:
facilitating the transfer of bonds from the trader to the winning bidder according to the terms of the trader criteria and the winning bid.

10. The method of claim 7, wherein the trader criteria includes:
a term; and
a range of acceptable interest rates.

11. The method of claim 7, wherein the trader criteria includes information pertaining to acceptable risk.

12. The method of claim 7, wherein the bond trade criteria are non-standard compared to typical industry practices.

13. The method of claim 12, further comprising the step of:
apprising member trading houses of the non-standard bond trade criteria.

14. The method of claim 7, wherein the step of accepting at least one bid from at least one acceptable bidder via the full-time public network comprises the step of:
reviewing at least one unfulfilled standing bid to determine whether the unfulfilled standing bid satisfies the bond trade criteria; and
automatically accepting unfulfilled standing bids that satisfy the bond trade criteria.

15. A system for auction-based transactional matching of traders and trading houses in order to achieve qualified placement of bonds so as to satisfy the criteria of trader and trading house, the system comprising:
at least one trader computing system adapted to communicably couple to an auctioneer computing system via the full-time public network;
at least one trading house computing system adapted to communicably couple to the auctioneer computing system via the full-time public network;
the auctioneer computing system adapted to communicably couple to the full-time public network, wherein the auctioneer computing system comprises:
a trader criteria module adapted to accept trader criteria from potential traders via the full-time public network;
a trading house criteria module adapted to accept trading house criteria from potential traders via the full-time public network;
an auction module adapted to perform an auction-based transactional matching of accepted trader criteria to accepted trading house criteria, wherein each criteria satisfies the requirements of the criteria to which it is matched;
a notification module adapted to notify, in response to the matching of an accepted trader criteria with an accepted trading house criteria, the corresponding trader and the corresponding trading house of the match via the full-time public network;
wherein the at least one trader computing system is adapted to communicably couple to the at least one trading house computing system following conclusion of the auction-based match in order to execute post-auction activity in accordance with the terms of the trader criteria and the trading house criteria.

16. The system of claim 15, wherein the auctioneer computing system further comprises:
a risk analytic module adapted to perform risk analytics on accepted trader criteria and accepted trading house criteria in order to facilitate matching.

17. The system of claim 15, wherein the risk analytic module comprises computer-readable instructions, the execution of which perform the step of:
performing risk analytics on accepted trader criteria and accepted trading house criteria in order to facilitate matching.

18. The system of claim 15, wherein the trader criteria module comprises computer-readable instructions, the execution of which perform the step of:
accepting trader criteria from potential traders via the full-time public network.

19. The system of claim 15, wherein the trading house criteria module comprises computer-readable instructions, the execution of which perform the step of:
accepting trading house criteria from potential traders via the full-time public network.

20. The system of claim 15, wherein the auction module comprises computer-readable instructions, the execution of which perform the step of:
performing an auction-based transactional matching of accepted trader criteria to accepted trading house criteria, wherein each criteria satisfies the requirements of the criteria to which it is matched.

21. A method for auctioning trading house bond trade opportunities to traders using a full-time public network, including the steps of:
establishing a connection to a full-time public network;
accepting trading house bond trade criteria received from a trading house via the full-time public network, including:
a bond trade amount;
a bond trade term;
a maximum specified interest rate;
accepting at least one bid from at least one trader via the full-time public network, the bid including a bid interest rate no more than the maximum specified interest rate;
selecting at least one winning bid from the accepted bids on the basis of its bid interest rate; and
notifying the trading house of the winning bid, including the identity of the winning bidder and the winning bid interest rate.

22. The method of claim 21, further including the steps of:
notifying the winning trader of the trading house's identity.

23. The method of claim 22, further including the step of:
facilitating the transfer of bonds from the winning trader to the trading house to fulfill the trading house bond trade opportunity according to the terms of the trading house bond trade criteria and the winning bid.
